(19) United States
(12) Patent Application Publication
(10) Pub. No.: US 2018/0170175 A1
(43) Pub. Date: Jun. 21, 2018

(54) NECK EXTENDER SLEEVES FOR USE ON VEHICLES SUCH AS RECREATIONAL VEHICLES (RV)

(71) Applicant: BELCAROL SOLUTIONS LIMITED, Sherwood Park (CA)

(72) Inventor: Gordon SCHRODER, Sherwood Park (CA)

(21) Appl. No.: 15/845,675

(22) Filed: Dec. 18, 2017

(30) Foreign Application Priority Data
Dec. 21, 2016 (CA) 2952476

(51) Int. Cl. B60K 15/04; B60K 15/077; F01P 11/02

(52) U.S. Cl. CPC B60K 15/04; B60K 2015/03019; F01P 11/0204; B60K 15/077

(57) ABSTRACT

An apparatus has: a recreational vehicle (RV); a fuel tank connected to supply an engine of the recreational vehicle (RV); a fuel filler neck connected to supply the fuel tank; a neck extender sleeve with a first threaded end secured to a threaded fuel inlet of the fuel filler neck; and a fuel cap secured to a second end of the neck extender sleeve. A method has the following steps: supplying fuel from a fuel nozzle into a neck extender sleeve, through a fuel filler neck, and into a fuel tank of a recreational vehicle (RV); and in which the neck extender sleeve is threaded to the fuel filler neck, and the fuel filler neck is connected to the fuel tank.

### TECHNICAL FIELD

This document relates to neck extender sleeves for use on vehicles such as recreational vehicles (RV).

### BACKGROUND

The fuel filler neck of a fuel tank on a vehicle may be inset within a cavity defined by a decorative fiberglass shroud.

### SUMMARY

An apparatus is disclosed comprising: a recreational vehicle (RV); a fuel tank connected to supply an engine of the recreational vehicle (RV); a fuel filler neck connected to supply the fuel tank; a neck extender sleeve with a first threaded end secured to a threaded fuel inlet of the fuel filler neck; and a fuel cap secured to a second end of the neck extender sleeve.

An apparatus is also disclosed comprising: a vehicle; a fuel tank; a fuel filler neck connected to supply the fuel tank; a neck extender sleeve with a first threaded end secured to a threaded fuel inlet of the fuel filler neck; a fuel cap secured to a second end of the neck extender sleeve; and in which an access end of the threaded fuel inlet is inset, within a cavity defined by, a shroud that at least partially encircles the threaded fuel inlet.

A method is also disclosed comprising: supplying fuel from a fuel nozzle into a neck extender sleeve, through a fuel filler neck, and into a fuel tank of a recreational vehicle (RV); and in which the neck extender sleeve is threaded to the fuel filler neck, and the fuel filler neck is connected to the fuel tank.

A sleeve is also disclosed with a threaded box end to connect to an inlet of a fuel tank on a vehicle, and a threaded pin end to mount the cap for the fuel tank. There may be a gasket and set screw associated with securing the threaded box end. The sleeve may be mounted to a fuel tank of a recreational vehicle (RV), in which the inlet of the RV's fuel tank is inset within a shroud, and the sleeve extends the threaded pin end to beyond the shroud.

In various embodiments, there may be included any one or more of the following features: The first threaded end has box threading secured to corresponding pin threading on the threaded fuel inlet and the second end has pin threading secured to corresponding box threading on the fuel cap. Threading on the fuel cap is structured to secure to corresponding threading on the threaded fuel inlet. An access end of the threaded fuel inlet is inset, within a cavity defined by, a shroud that at least partially encircles the threaded fuel inlet. The shroud has a curved side wall that defines the cavity that receives the threaded fuel inlet. The second end of the neck extender sleeve protrudes beyond the shroud. The shroud is adjacent or defined within a stair that leads into the vehicle. The shroud is defined within a tread of the stair, and the threaded fuel inlet is below a plane defined by the tread. The shroud forms part of a cover for the fuel tank. The fuel cap is inset within a plane defined by an adjacent side wall of the vehicle. A gasket is mounted between the first threaded end and the threaded fuel inlet. The neck extender sleeve has a lock for securing the first threaded end to the threaded fuel inlet. The lock comprises a set screw. The threaded fuel inlet is located within a side of the vehicle. The fuel nozzle is part of a trigger-operated liquid fuel dispenser, and further comprising, prior to supplying fuel, inserting the fuel nozzle into an open end of the neck extender sleeve. Prior to supplying fuel, threading a first end of the neck extender sleeve to the fuel filler neck; and after supplying fuel, threading a fuel cap to a second end of the neck extender sleeve. Threading on the fuel cap is structured to secure to corresponding threading on the fuel filler neck. The fuel comprises diesel. After supplying fuel, the neck extender sleeve is disconnected from the fuel filler neck. The vehicle is a recreational vehicle (RV).

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a neck extender sleeve attached to a fuel inlet of a recreational vehicle (RV).

FIG. 2 is an exploded perspective view of a neck extender sleeve, a fuel inlet of a recreational vehicle (RV), and a fuel cap.

FIG. 3 is an exploded partial-section view of the neck extender sleeve, fuel cap and threaded inlet from FIG. 1, with the drawing showing a cross-sectional view on the left, and an elevation view on the right.

FIG. 3A is a section view taken along the 3A-3A section lines in FIG. 3.

FIG. 3B is a section view of the neck extender sleeve and threaded fuel inlet receiving fuel from a fuel nozzle.

FIG. 4 is a perspective view of a recreational vehicle (RV).

FIG. 4A is a perspective close up view of the segment shown in dashed lines in FIG. 4.

FIG. 5 is a schematic showing the connectivity of various components of the vehicle of FIG. 4.

### DETAILED DESCRIPTION

Immaterial modifications may be made to the embodiments described here without departing from what is covered by the claims.

A recreational vehicle (RV) is a type of vehicle which may be equipped with a living space and amenities found in a home, for example one or more of a bed, a kitchen, and a bathroom. Examples of RVs include: camper vans, caravans, motorhomes, motor coaches, travel camper trailers, fifth wheel camper trailers, pop-up camper trailers, slide-in campers, and others. RVs may be used for leisure activities such as camping and vacations. RVs may be found in parks, campgrounds, and may be rented or sold in most major cities and tourist areas. An RV may be a passive unit or a driven unit. Other types of vehicles may incorporate living spaces, such as tractor trucks, light commercial trucks, and others.

An RV may incorporate a power system, such as an engine, for achieving any of a number of different functions. The RV may comprise an internal or external fuel tank that supplies fuel to the engine. The engine may provide power to one or more a) ground engaging members, such as wheels or tracks, b) electrical components, and c) a heating unit within the RV. In some cases, the RV will have an auxiliary fuel tank, such as a diesel, gasoline, or propane tank as supplemental fuel for long hauls or for providing power to components of the living space. Recreational vehicles may include vehicles without a living space.

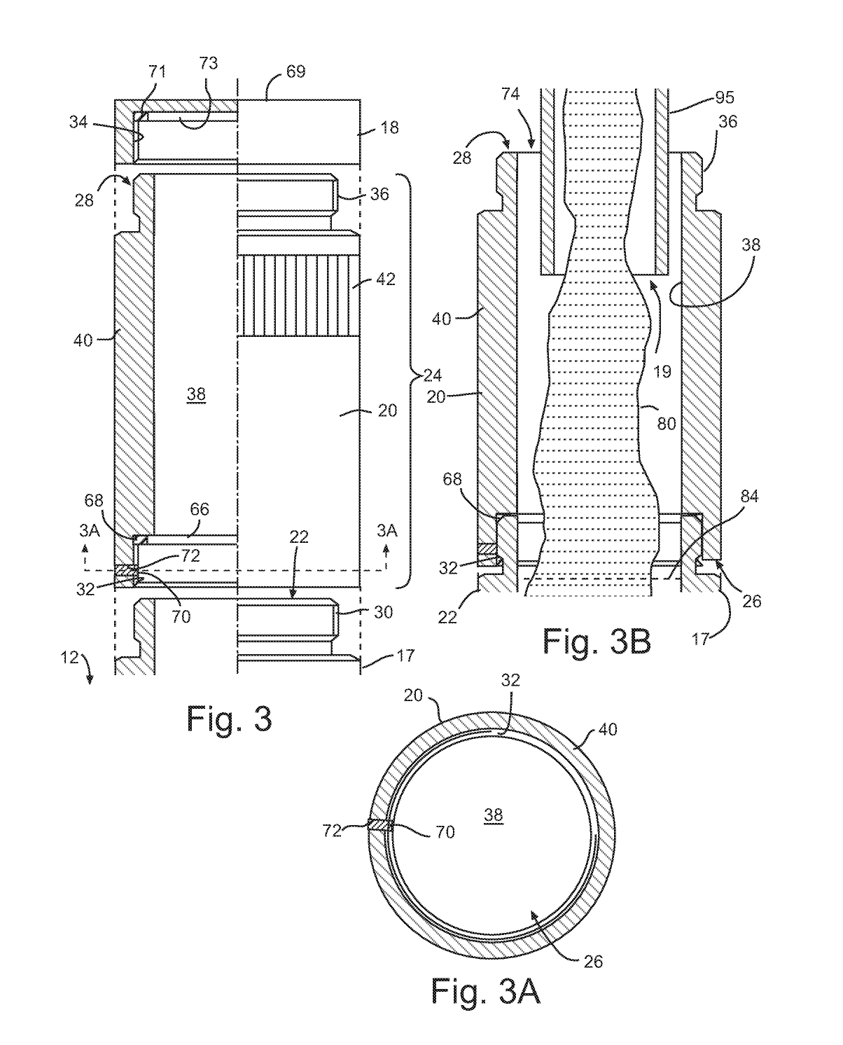

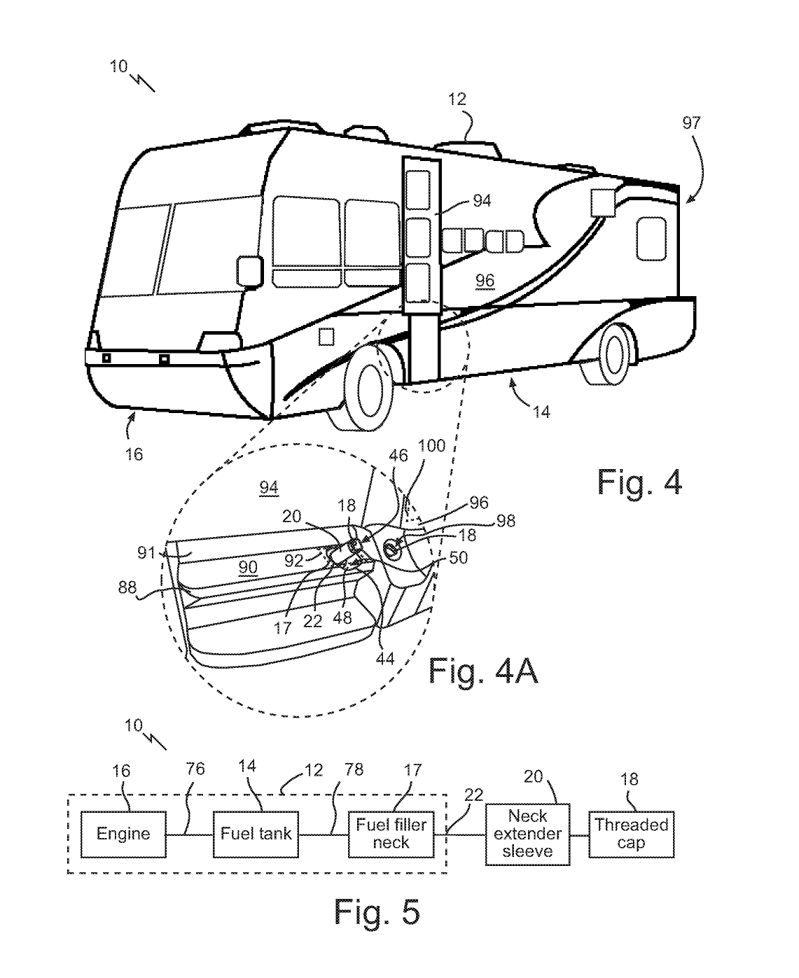

Referring to FIGS. 3, 4, 4A, and 5, an apparatus 10 is disclosed comprising a vehicle 12, for example a recreational vehicle (RV), a fuel tank 14, a fuel filler neck 17, and a neck extender sleeve 20. Referring to FIGS. 3 and 4A, fuel filler neck 17 may be connected to supply the one or more fuel tanks 14. A threaded fuel inlet 22 may be formed by the fuel filler neck 17 to act as an access point for refueling fuel tank 14. Fuel filler neck 17 may act to bridge the fuel inlet 22 to the fuel tank 14. Referring to FIG. 5, fuel tank 14 may be connected to supply, for example via a supply line 76, an engine 16 of the vehicle 12. Fuel filler neck 17 may extend directly off the fuel tank 14 or may connect to the fuel tank 14 via a supply line 78. Referring to FIGS. 4 and 4A, sleeve 20 may secure to a threaded fuel inlet 22 of vehicle 12. Inlet 22 may be located within a side wall 96, such as the left, right, front or rear side of the recreational vehicle 12. In some cases, inlet 22 is located at a rear end 97 of vehicle 12. A fuel cap 18 may be used to seal off the neck extender sleeve 20 between fills.

Referring to FIG. 3, sleeve 20 may have a suitable structure to extend the fuel inlet 22. Sleeve 20 may comprise a body 24 with a first end 26 and a second end 28. Referring to FIGS. 3 and 3B, first end 26 may be threaded and structured to secure to the threaded fuel inlet 22 of the filler neck 17. Threaded fuel inlet 22 may have pin (male) or box (female) threads 30 and first end 26 may have complimentary threads 32, such as box or pin threads, respectively. The fuel cap 18 may secure to second end 28 of sleeve 20. In the example shown fuel cap 18 has box threading 34 and second end 28 has corresponding pin threading 36. Fuel cap 18 may secure to second end 28 by a suitable connection method, such as a non-threaded connection, such as interference fit, friction fit, cam lock and others.

Referring to FIGS. 3 and 3B, sleeve 20 may comprise various features. Sleeve 20 may define an internal fuel bore or passageway 38 within body 24. Internal fuel passageway 38 may extend between the first threaded end 26 and the second end 28 to permit the flow of fuel from nozzle 19 to inlet 22. Internal fuel passageway 38 may be defined by an encircling side wall 40. Side wall 40 may be structured, for example textured to define a plurality of grooves 42, to improve grip and assist the user during installation of sleeve 20 to inlet 22. Grooves 42 may permit the user to have a firmer grip during connection and disconnection. Grooves 42 may be formed by an appropriate process, such as knurling.

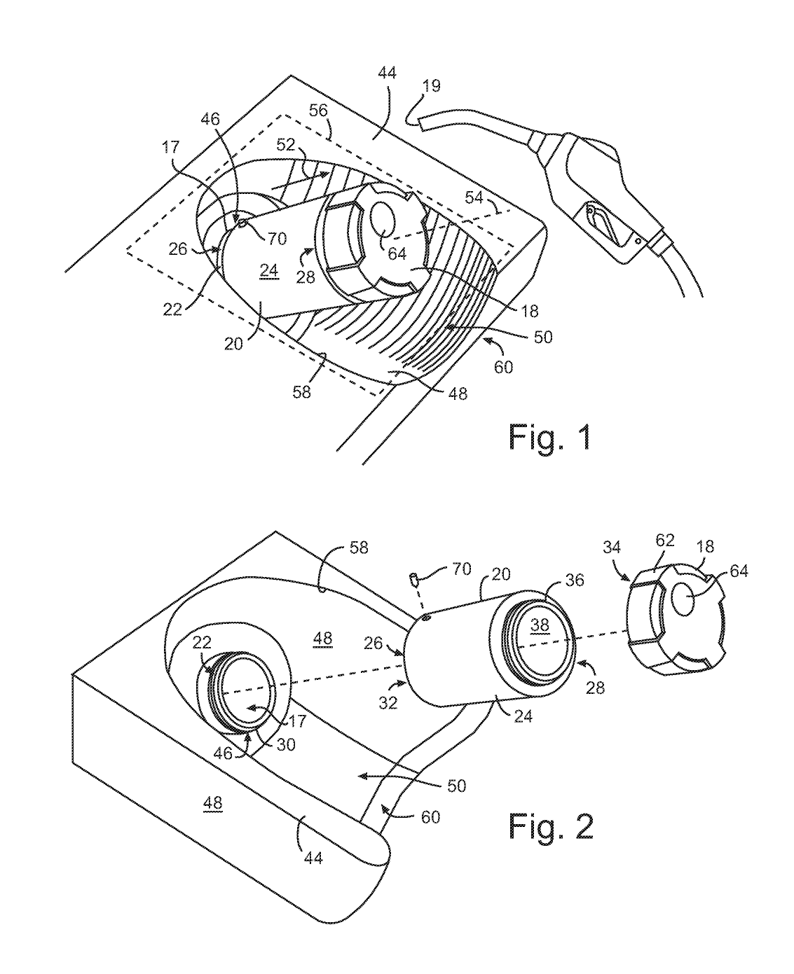

Referring to FIGS. 1 and 2, a shroud 44, such as a decorative shroud forming part of a cover for the fuel tank as shown, may be provided adjacent the inlet 22 to provide access to the inlet 22. Referring to FIGS. 1 and 2, the shroud 44 may be structured such that an access end 46 of the inlet 22 is inset, within a cavity 50 defined by, shroud 44. Shroud 44, for example a side wall 48 of the shroud 44, may at least partially encircle the threaded fuel inlet 22. Side wall 48 may define cavity 50, such as a concave cavity, that receives inlet 22. Side wall 48 may extend over the access end 46 in a direction along an axis 54 of the inlet 22, for example if an outer rim 58 defines a plane 56, and the access end 46 is contained within the volume of space defined by the plane 56 and the cavity 50.

Shroud 44 may have various suitable features. Shroud 44 may comprise a continuous or broken side wall 48. In the example shown the side wall 48 wraps most of the circumferential distance around the inlet 22, with continuity broken to define a fuel nozzle access mouth 60. Mouth 60 may facilitate access to the inlet 22 via a fuel nozzle 19. In some cases, cavity 50 lacks a covering mechanism, such as a cap, door, or other suitable cover. Shroud 44 may be defined by a wall of the vehicle 12.

The shroud may have a suitable shape. A curved side wall 48, such as a side wall 48 that is curved in one or more of a plane or series of planes perpendicular to the axis 54, or a plane or series of planes parallel to axis 54. The surface of side wall 48 defining cavity 50 may be sloped downward towards the inlet, for example to permit any fuel spilled during operation to pool within the cavity 50 and not to drain off into the adjacent environment. Inlet 22 may be located at a trough (a local minimum elevation point) defined within the cavity 50. Cavity 50 may be concave in shape, or may have other shapes, including non-concave shapes. The side wall 48 may be formed by a series of posts that extend from a wall of the vehicle. The side wall 48 may form a cylindrical passageway.

Referring to FIGS. 1 and 2, the shroud 44 may make it challenging to refuel the RV. For example, shroud 44 may encumber access to inlet 22 for refueling by a fuel source, such as a trigger-operated fuel nozzle 19, potentially causing spills when the nozzle 19 is being inserted into and removed from the cavity 50. Moreover, the shroud 44, which may be made from fiberglass, polymeric material, or other suitable materials, may receive unsightly marking, dents, and scarring from repeated contact with the fuel nozzle 19 over time. For example, a decorative shroud formed by a fiberglass fuel tank cover may be particularly susceptible to damage from repeated contact. A fiberglass shroud is an example of a part that crumples under external contact, and hence may be provided for decorative and inlet access purposes only.

Referring to FIG. 1, sleeve 20 may increase user access to fuel inlet 22. After sleeve 20 has been connected to inlet 22, second end 28 (external end) of sleeve 20 may protrude beyond, for example at least partially beyond, side wall 48 and shroud 44. Sleeve 20 may extend, in a direction, such as an upward direction 52, away from fuel inlet 22. Sleeve 20 may extend, for example coaxially, along an axis 54 defined by inlet 22. Protruding may be understood as sleeve 20 and second end 28 extending out of cavity 50 and past plane 56 defined by outer rim 58 of the shroud 44, effectively increasing the length of the neck 17.

Referring to FIG. 4A, shroud 44 may be adjacent or defined within a stair 88 that leads into the vehicle. In some cases, stair 88 is cutout to define cavity 50 and side wall 48, thus integrating the shroud 44 into the stair 88. Stair 88 may comprise a tread 90 and a rise 91. Shroud 44 may be defined within tread 90, for example as is the case with a JAYCO™ SENECA™ RV. Tread 90 may define a plane 92, for example a horizontal plane. Inlet 22 may be inset within, for example located below, plane 92. Second end 28 of sleeve 20 may protrude out of cavity 50 above plane 92. Stair 88 may comprise a set of stairs, each with a corresponding tread 90 and rise 91. Stair 88 may lead to a door 94 of the vehicle.

Referring to FIGS. 2 and 3, fuel cap 18 may have a suitable structure. In some cases, cap 18 is structured to secure to the fuel inlet 22 when sleeve 20 is not present, for example if the cap 18 is the original factory-provided cap 18 that comes with the vehicle from the manufacturer. In such a case the threading 34 of cap 18 may be structured to match and thread to the corresponding threading 30 of inlet 22. Sleeve 20 may have box and pin threading 32 and 36, respectively, that matches the pin threading 30 of inlet 22 and the box threading of cap 18, respectively. Cap 18 may be structured to improve gripping by a user when connecting or disconnecting cap 18 to sleeve 20 or inlet 22, for example via a suitable mechanism such as ridges 62. Cap 18 may comprise a pressure-release vent or valve 64 that vents gas when the pressure within the cap 18 rises above a predetermined threshold. Cap 18 may comprise a locking mechanism (not pictured) that secures cap 18 to the second end 28 or inlet 22, for example a lock and key. Referring to FIG. 4A, in some cases, the fuel inlet 22 and cap 18 are located within a cavity 98 defined by a side wall 96 of the recreational vehicle 12. Fuel cap 18 may be inset within a plane 100 defined by the adjacent side wall 96, to avoid or minimize contact with objects or vehicles that contact the sidewall 96. The side wall 96 of the vehicle 12 may be defined as the parts of the vehicle that define the maximum dimensions of the vehicle 12.

Referring to FIG. 3, sleeve 20 may comprise a sealing member, such as a gasket 68. Gasket 68, which may be an annular O-ring as shown, may be mounted in a groove 66 defined by side wall 40. Gasket 68 and groove 66 may be located between the first threaded end 26 and the thread fuel inlet 22, for example if such are located and defined, respectively on the sleeve 20 as shown. Gasket 68 may assist in preventing leakage of liquid or gaseous fuel across the threaded connection between the sleeve 20 and inlet 22. In some cases, a gasket 71, such as an O-ring, is located in a groove 73 within cap 18 between the second threaded end 28 and a top part 69 of cap 18. There may be a plurality of gaskets present. Each gasket may be comprised of rubber, plastic, soft metal, or other suitable material.

Referring to FIGS. 3 and 3A, sleeve 20 may comprise a lock 70. Lock 70 may secure the first threaded end 26 to the threaded fuel inlet 22. Lock 70 may engage the pin threading 30 of the fuel inlet 22 and prevent the sleeve 20 from being removed. Lock 70 may comprise a set screw (shown), pin, nut, and others. Lock 70 may be inserted into a corresponding passageway 72 (FIG. 3A) that passes through side wall 40, for example to form a lateral passageway from an exterior of the sleeve 20 to interior passageway 38. Lock 70 may be threaded into passageway 72. In some cases, lock 70 comprises a plurality of locks that engage the pin threading 30 and the pin threading 36 of sleeve 20. The lock 70 may prevent the sleeve 20 from being unthreaded when the fuel cap 18 is being unthreaded.

Referring to FIGS. 1, 3B, and 5, a method of use of apparatus 10 is depicted. A fuel cap 18, if initially present, may be removed from around the inlet 22. Sleeve 20 may be then connected to fuel inlet 22 by threading first end 26 to the fuel filler neck 17. First end 26 may be further secured to the threading 30 by lock 70, particularly if the sleeve 20 is to remain secured to the fuel fill neck 17 over an extended period of time, for example over plural cycles of filling the tank 14, operating the vehicle 12 to at least partially drain the fuel tank 14, and filling the tank 14 again. Fuel cap 18 may be secured to seal off the second end 28 of the sleeve 20. Referring to FIGS. 3 and 3B, to fill the tank 14, the cap 18, if present, may be disconnected from sleeve 20 to expose an open end 74 of sleeve 20.

Fuel may be supplied through the sleeve 20 into the tank 14. Referring to FIG. 3B, fuel nozzle 19, such as a nozzle on a trigger-operated liquid fuel dispenser 95, may then be inserted into open end 74. A user may supply fuel 80, for example a suitable liquid fuel such as diesel, from fuel nozzle 19 into neck extender sleeve 20, through fuel filler neck 17, and into a fuel tank 14 of the vehicle 12. Fuel may be filled to a suitable fill level 84. After fuel 80 has been supplied to fuel tank 14, nozzle 19 may be withdrawn from open end 74 and cap 18, if present, may be connected to second end 28.

At some point after operation, sleeve 20 may be disconnected from fuel filler neck 17. For example, disconnection may be desired after a long series of cycles of filling and draining (by operating the engine) the fuel tank 14 without removing the sleeve 20. The lock 70, if present, may be removed or unlocked and first end 26 unthreaded from the threading 30 of neck 17. In some cases, sleeve 20 comes pre-installed on the filler neck 17 of the recreational vehicle upon retail or wholesale purchase of the vehicle from a distributor or manufacturer, respectively. LOCTITE™ or other adhesives may be used to secure sleeve 20 to neck 17. Sleeve 20 may be a permanent or semi-permanent installation on vehicle 12. Sleeve 20 may be sold separately and retrofitted on a suitable vehicle 12.

A lock (not shown) may be used to secure the cap 18 to the sleeve 20, for example a screw that passes through the cap 18 to engage the pin threading 36 of sleeve 20 to lock the cap 18 in place. The fuel tank 14 may be an auxiliary fuel tank. The fuel tank may or may not be connected to the engine. The sleeve 20 may be installed on vehicles that lack a living space, for example some tractor trucks and sport utility vehicles (SUV). The fuel tank may have a fuel capacity of forty or more liters, or other suitable volumes greater than or smaller than forty liters. A sleeve includes a collar, pipe, or other structure forming a fluid conduit. The sleeve may be made of a suitable material, such as machined steel. Sleeve 20 may increase user access to fuel inlet 22 even when no shroud 44 is present.

In some cases the sleeve 20 may be used to extend an inlet inset within a protective guard that forms the shroud that houses the inlet 22, to protect the inlet 22 from damage from force transfer through the inlet 22 via contact between the inlet 22 and a surrounding object, such as a branch, vehicle, or object. Other protective mechanisms may be used such as a door.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An apparatus comprising:
a recreational vehicle (RV);
a fuel tank connected to supply an engine of the recreational vehicle (RV);
a fuel filler neck connected to supply the fuel tank;
a neck extender sleeve with a first threaded end secured to a threaded fuel inlet of the fuel filler neck; and
a fuel cap secured to a second end of the neck extender sleeve.

2. The apparatus of claim 1 in which:
the first threaded end has box threading secured to corresponding pin threading on the threaded fuel inlet; and
the second end has pin threading secured to corresponding box threading on the fuel cap.

3. The apparatus of claim 1 in which threading on the fuel cap is structured to secure to corresponding threading on the threaded fuel inlet.

4. The apparatus of claim 1 in which an access end of the threaded fuel inlet is inset, within a cavity defined by, a shroud that at least partially encircles the threaded fuel inlet.

5. The apparatus of claim 4 in which the shroud has a curved side wall that defines the cavity.

6. The apparatus of claim 4 in which the second end of the neck extender sleeve protrudes beyond the shroud.

7. The apparatus of claim 4 in which the shroud is adjacent or defined within a stair that leads into the recreational vehicle (RV).

8. The apparatus of claim 7 in which the shroud is defined within a tread of the stair, and the threaded fuel inlet is below a plane defined by the tread.

9. The apparatus of claim 4 in which the shroud forms part of a cover for the fuel tank.

10. The apparatus of claim 1 in which the fuel cap is inset within a plane defined by an adjacent side wall of the recreational vehicle (RV).

11. The apparatus of claim 1 in which a gasket is mounted between the first threaded end and the threaded fuel inlet.

12. The apparatus of claim 1 in which the neck extender sleeve has a lock for securing the first threaded end to the threaded fuel inlet.

13. The apparatus of claim 12 in which the lock comprises a set screw.

14. The apparatus of claim 1 in which the threaded fuel inlet is located within a side of the recreational vehicle (RV).

15. A method comprising:
supplying fuel from a fuel nozzle into a neck extender sleeve, through a fuel filler neck, and into a fuel tank of a recreational vehicle (RV); and
in which the neck extender sleeve is threaded to the fuel filler neck, and the fuel filler neck is connected to the fuel tank.

16. The method of claim 15 in which the fuel nozzle is part of a trigger-operated liquid fuel dispenser, and further comprising, prior to supplying fuel, inserting the fuel nozzle into an open end of the neck extender sleeve.

17. The method of claim 15 further comprising:
prior to supplying fuel, threading a first end of the neck extender sleeve to the fuel filler neck; and
after supplying fuel, threading a fuel cap to a second end of the neck extender sleeve.

18. The method of claim 17 in which threading on the fuel cap is structured to secure to corresponding threading on the fuel filler neck.

19. The method of claim 15 in which the fuel comprises diesel.

20. The method of claim 15 further comprising, after supplying fuel, disconnecting the neck extender sleeve from the fuel filler neck.

21. An apparatus comprising:
a vehicle;
a fuel tank;
a fuel filler neck connected to supply the fuel tank;
a neck extender sleeve with a first threaded end secured to a threaded fuel inlet of the fuel filler neck;
a fuel cap secured to a second end of the neck extender sleeve; and
in which an access end of the threaded fuel inlet is inset, within a cavity defined by, a shroud that at least partially encircles the threaded fuel inlet.
